(19) United States
(12) Patent Application Publication
(10) Pub. No.: US 2010/0169716 A1
(43) Pub. Date: Jul. 1, 2010

(54) MANAGING CONFIDENCE LEVELS IN A COMPUTING SYSTEM

(76) Inventors: Shmuel Ben-Yehuda, Haifa (IL); Michael E. Factor, Haifa (IL); Aviad Zlotnick, Mitzpeh Netofah (IL)

Correspondence Address: CENTURY IP GROUP, INC. [IBM US], P.O. BOX 7333, NEWPORT BEACH, CA, 92658-7333, US

(21) Appl. No.: 12/346,777

(22) Filed: Dec. 30, 2008

(51) Int. Cl. G06Q 99/00

(52) U.S. Cl. 714/48

(57) ABSTRACT

A method for managing confidence levels in a computing system is provided. The method comprises determining a first confidence level associated with a first operation performed in the computing system. The first confidence level indicates probability that the first operation was performed successfully and is calculated based on attributes of one or more components in the computing system. Once the first confidence level is determined, the first confidence level is compared to a confidence threshold for the first operation. If the first confidence level is less than the confidence threshold, a first remedial action is taken to raise the first confidence level.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### TECHNICAL FIELD

The present invention relates generally to a computing environment and, more particularly, to managing confidence levels in a computing system.

### BACKGROUND

Typically, a system designer provides various heuristics or “rules of thumb” to determine confidence levels for certain results computed in a particular system. A confidence level refers to the degree of certainty with which the computed results comply with a particular standard or specification.

If a confidence level is not high enough for an intended purpose, the designer may use software-based methods to raise the confidence level. For example, an important computation may be repeated several times to ensure that the final result is correct.

The above methods are unfortunately expensive to develop and inefficient with respect to resource utilization. Furthermore, such methods are implemented when the system is first designed, not during run-time, so typically such implementations may not provide the best strategy for enhancing the system's reliability. Methods and systems are needed to overcome the aforementioned shortcomings.

### SUMMARY

The present disclosure is directed to systems, methods, and corresponding products that facilitate managing confidence levels in a computing system.

For purposes of summarizing, certain aspects, advantages, and novel features of the invention have been described herein. It is to be understood that not all such advantages may be achieved in accordance with any one particular embodiment of the invention. Thus, the invention may be embodied or carried out in a manner that achieves or optimizes one advantage or group of advantages without achieving all advantages as may be taught or suggested herein.

In accordance with one embodiment, a method for managing confidence levels in a computing system is provided. The method comprises determining a first confidence level associated with a first operation performed in the computing system. The first confidence level indicates probability that the first operation was performed successfully and is calculated based on attributes of one or more components in the computing system. Once the first confidence level is determined, the first confidence level is compared to a confidence threshold for the first operation. If the first confidence level is less than the confidence threshold, a first remedial action is taken to raise the first confidence level.

In accordance with another embodiment, a system comprising one or more logic units is provided. The one or more logic units are configured to perform the functions and operations associated with the above-disclosed methods. In accordance with yet another embodiment, a computer program product comprising a computer useable medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1 illustrates an exemplary computing system, in accordance with one embodiment.

FIG. 2A is a flow diagram of a method for managing the confidence level associated with a single operation, in accordance with one embodiment.

FIG. 2B is a flow diagram of a method for managing the confidence level associated with an instruction stream, in accordance with one embodiment.

FIGS. 3 and 4 are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION OF EXAMPLE EMBODIMENTS

The present disclosure is directed to systems and corresponding methods that facilitate managing confidence levels in a computing system.

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

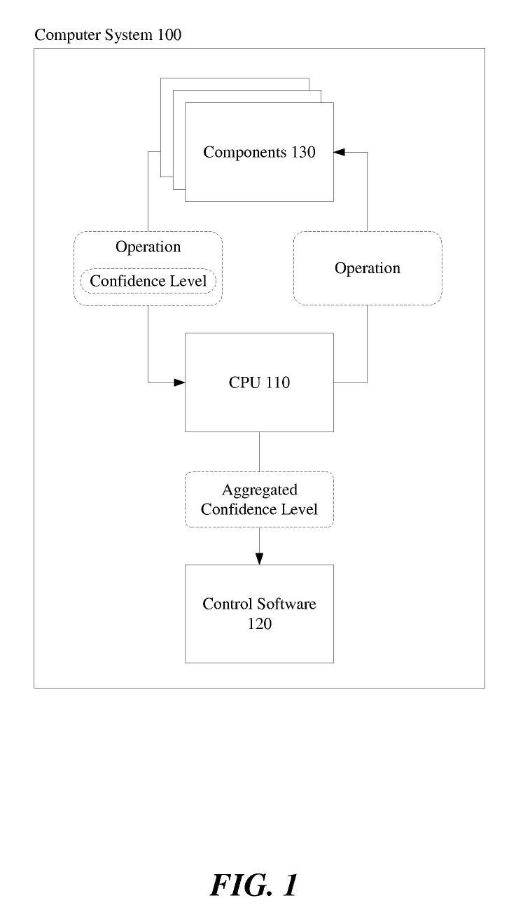

Referring to FIG. 1, in accordance with one embodiment, an exemplary computing system 100 comprises a central processing unit (CPU) 110, control software 120, and one or more components 130. CPU 110 may comprise one or more processors that send certain operation requests to components 130. Different components 130 may be involved with different operations (e.g., read or write operations may be directed to a storage device ) Control software 120 determines the action that CPU 110 takes if it is determined that computing system 100 or one or more of its components 130 are not sufficiently reliable or not operating at a predetermined confidence level.

In one embodiment, computing system 100 may also comprise certain circuitry (e.g., in a separate chip or in the CPU 110) for determining confidence levels. The circuitry may have extra shielding from radiation, high tolerance to temperature variations, or other characteristics to increase the confidence level of the circuitry, lowering the likelihood of errors during confidence determinations in particular.

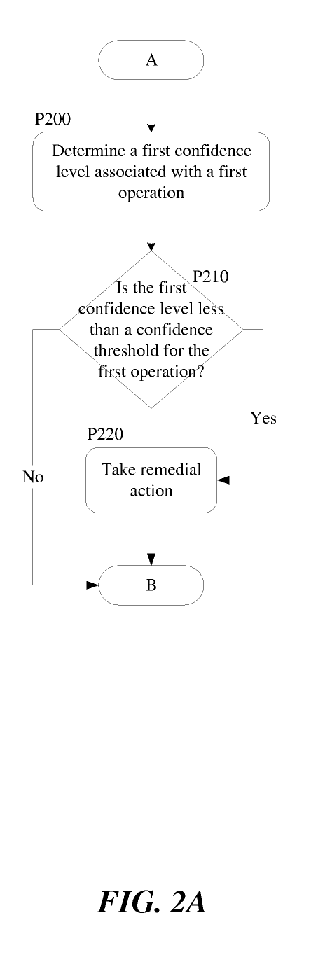

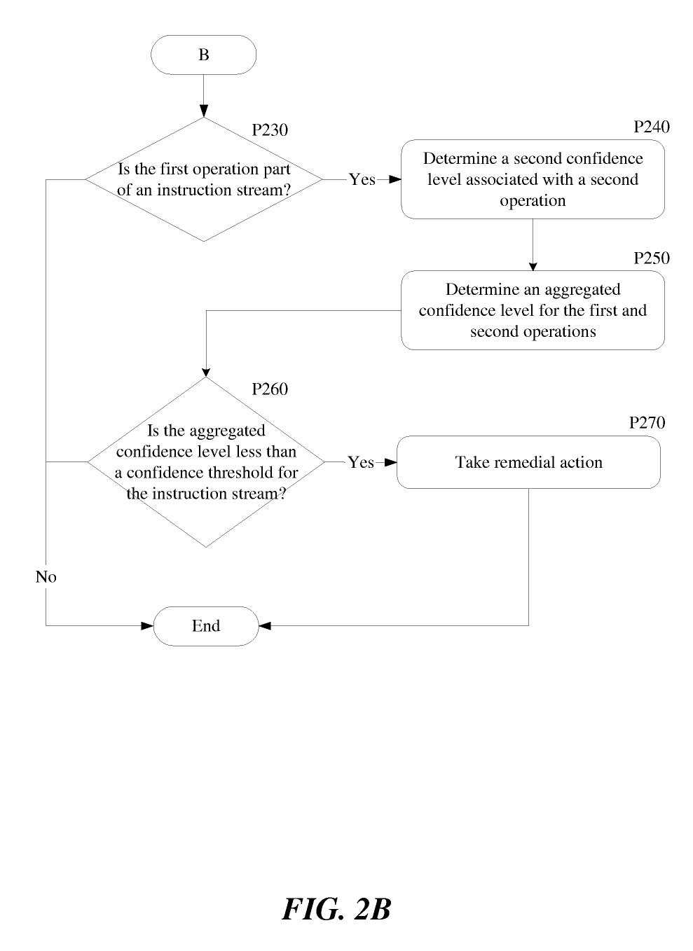

The confidence level of computing system 100 as a whole may be determined based on the collective confidence levels of its individual components 130. Referring to FIGS. 1 and 2A, in accordance with one embodiment, control software 120 determines a confidence level associated with an operation performed by a component 130 (P200).

In one embodiment, the confidence level associated with the operation may be a numerical value ranging from 0 to 1, for example. Zero may, for example, indicate that it cannot be determined whether the result of the operation is correct, and one may, for example, indicate that the result of the operation is correct. A value in between 0 and 1 in turn may indicate the probability that the result of the operation is correct, for example. It is noteworthy that other exemplary reliability valuation or measurement schemes may be utilized.

Depending on implementation, the confidence level may be statically set to a default value or dynamically assigned based on certain attributes associated with one or more components 130 in computing system 100. Such attributes may include environmental factors such as heat, power consumption, life-time of a component, or other pertinent factors. The confidence level may be set or assigned (i.e., provided) by the component 130 that performed the operation or by another system component, whether implemented in hardware, software, or a combination thereof. In one embodiment, for example, the confidence level may be provided by the component 130 that performed the operation according to a strategy implemented by the component 130's manufacturer.

The confidence level may also be provided according to the complexity of the component 130 that performed the operation. If the component 130 is a simple component, the confidence level may be provided according to a simple strategy (e.g., if the current temperature is within the standard operating temperature, the confidence level is set to 1; otherwise, the confidence level is set to 0). If the component 130 is a complex component, the confidence level may be provided according to a complex strategy that depends on a multitude of factors (e.g., using a formula that takes into account the current temperature, amount of ambient dust, voltage fluctuations, and average amount of use in the last 30 days).

Referring back to FIGS. 1 and 2A, once the confidence level for an operation is determined (P200), control software 120 compares the confidence level to a predetermined confidence threshold for the operation (P210) and takes remedial action if the confidence level is lower than the confidence threshold for the operation (P220). The remedial action taken may comprise generating a warning (e.g., signaling that the component 130 is not functioning properly), determining a solution to increase the confidence level above the predetermined confidence threshold (e.g., repeating the operation, performing an alternative operation, performing maintenance), or other remedial actions.

Referring to FIGS. 1 through 2B, in accordance with one embodiment, if the target operation is part of an instruction stream that comprises multiple operations (P230), control software 120 determines the confidence levels for each of the operations (P240). Upon determining the assigned confidence level for each operation, control software 120 determines an aggregated confidence level for the operations collectively (P250). Depending on implementation, the aggregated confidence level may be calculated by CPU 100 or other system component.

In one embodiment, CPU 100 may calculate the aggregated confidence level for multiple operations by, for example, combining the confidence levels for the multiple operations into a single value using an exponential decay or some other suitable function. The aggregated confidence level may be calculated for an exemplary instruction stream comprising a first and a second operation according to the following equations, for example:

agg_conf=(½*conf_{—}1)+(½*conf_{—}2); or

log (agg_conf)=log (conf_{—}1)+log (conf_{—}2); or

log (agg_conf)=min (log (conf_{—}1), log (conf_{—}2))

agg_conf refers to the aggregated confidence level, conf_{—}1 refers to the confidence level of the first operation conf_{—}2 refers to the confidence level of the second operation, log refers to taking the logarithm of a value, and min refers to taking the minimum of one or more values.

The calculated confidence level may be stored in a dedicated CPU register, or confidence register, that may be read from and written to by user software (e.g., to reset the confidence register after some remedial action). Upon determining the aggregated confidence level, control software 120 compares the aggregated confidence level to a confidence threshold for the instruction stream (P260) and takes remedial action if the aggregated confidence level is lower than the confidence threshold for the instruction stream (P270).

Advantageously, because control software 120 is able to determine the current confidence level of an operation or an instruction stream comprising multiple operations, control software 120 may take action in response to a low confidence level during run-time, instead of relying on embedded design implementations from when computing system 100 was first manufactured.

For example, in accordance with one embodiment, control software 120 may check the current confidence level of a request to read data from a disk. The read request (i.e., instruction stream) may comprise multiple operations such as retrieving the data from the cache, reading the data from the disk, writing the data to system memory, and other operations, each of which has a chance of failing (e.g., the wrong data may be read, the data may be written to the wrong location, the data may become corrupted before being used, or other errors may occur).

Each operation involved in reading the data may be associated with a confidence level provided by the component 130 that performed the operation. For example, the cache controller may provide a confidence level for a cache operation, the disk controller may provide a confidence level for a disk operation, and other components 130 may provide confidence levels to other operations performed, respectively. Upon checking the confidence register, control software 120 may take remedial action, during or immediately after execution of the read request, if the aggregated confidence level is below a predetermined confidence threshold (i.e., if there is a high probability that there was an error in reading the data from the disk).

It is noteworthy that determining confidence levels is distinctly different from determining floating point errors. In particular, the methods provided herein for determining confidence levels are probabilistic and measure the likelihood that an error occurred during one or more operations, whereas methods related to determining floating point errors are deterministic and the errors are actually specified during the determination.

In different embodiments, the invention may be implemented either entirely in the form of hardware or entirely in the form of software, or a combination of both hardware and software elements. For example, computing system 100 may be presented largely in terms of hardware components and software code executed to perform processes that achieve the results contemplated by the system of the present invention.

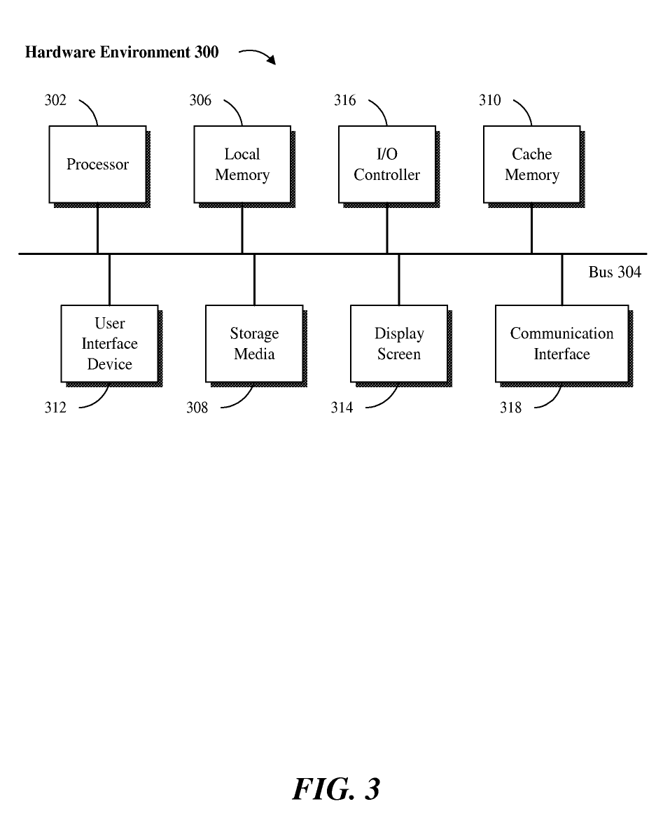

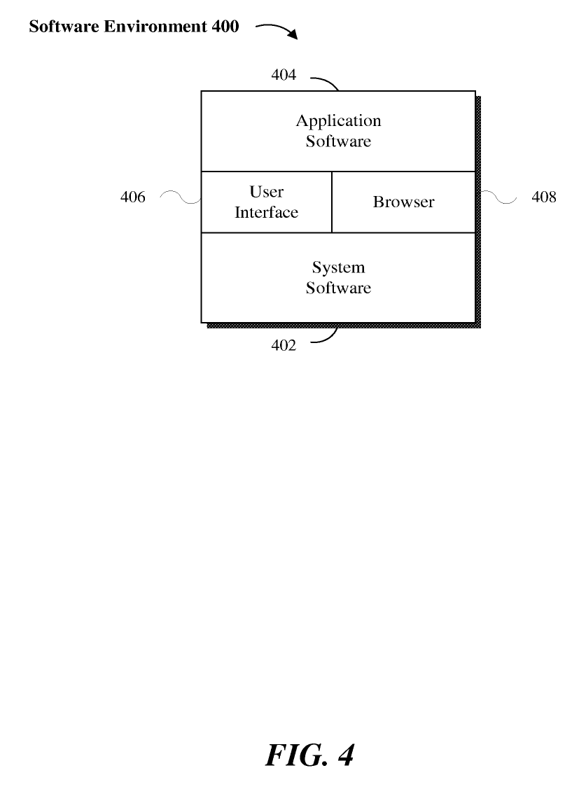

Referring to FIGS. 3 and 4, a computing system environment in accordance with an exemplary embodiment is composed of a hardware environment 300 and a software environment 400. The hardware environment 300 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 400 is divided into two major classes comprising system software 402 and application software 404. System software 402 comprises control programs, such as the operating system (OS) and information management systems that instruct the hardware how to function and process information. In one embodiment, control software 130 may be implemented as system software 402 or application software 404 and may comprise but is not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital videodisk (DVD).

Referring to FIGS. 3 and 4, an embodiment of the system software 402 and application software 404 may be implemented as computer software in the form of computer readable code executed on a data processing system such as hardware environment 300 that comprises a processor 302 coupled to one or more computer readable media or memory elements by way of a system bus 304. The computer readable media or the memory elements, for example, can comprise local memory 306, storage media 308, and cache memory 310. Processor 302 loads executable code from storage media 308 to local memory 306. Cache memory 310 provides temporary storage to reduce the number of times code is loaded from storage media 308 for execution.

A user interface device 312 (e.g., keyboard, pointing device, etc.) and a display screen 314 can be coupled to the computing system either directly or through an intervening I/O controller 416, for example. A communication interface unit 318, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 300 may not include all the above components, or may comprise other components for additional functionality or utility. For example, hardware environment 300 may be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In certain embodiments of the system, communication interface 418 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIGS. 1 and 4, control software 120 may be implemented as system software 402 or application software 404 and may comprise one or more computer programs that are executed on top of the operating system after being loaded from storage media 308 into local memory 306. In a client-server architecture, application software 404 may comprise client software and server software.

Software environment 400 may also comprise browser software 408 for accessing data available over local or remote computing networks. Further, software environment 400 may comprise a user interface 406 (e.g., a graphical user interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps may be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

Therefore, it should be understood that the invention may be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

What is claimed is:

1. A method for managing confidence levels in a computing system, the method comprising:
determining a first confidence level associated with a first operation performed in the computing system,
wherein the first confidence level indicates probability that the first operation was performed successfully, and
wherein the first confidence level is calculated based on attributes of one or more components in the computing system.

2. The method of claim 1, further comprising:
comparing the first confidence level to a confidence threshold for the first operation; and
taking a first remedial action, in response to determining that the first confidence level is less than the confidence threshold.

3. The method of claim 2, wherein the first remedial action comprises generating a warning.

4. The method of claim 2, wherein the first remedial action comprises determining a solution to raise the first confidence level above the confidence threshold.

5. The method of claim 1, wherein the first confidence level is provided by a component that performed the first operation.

6. The method of claim 1, wherein the first confidence level is statically set to a default value.

7. A method for managing confidence levels in a computing system, the method comprising:
determining a first confidence level associated with a first operation performed in the computing system, wherein the first operation is part of a first instruction stream;
determining a second confidence level associated with a second operation performed in the computing system, wherein the second operation is part of the first instruction stream; and
determining an aggregated confidence level associated with the first instruction stream by combining the first and second confidence levels into a single value.

8. The method of claim 7, further comprising:
comparing the aggregated confidence level with a confidence threshold for the first instruction stream; and
taking a first remedial action, in response to determining that the aggregated confidence level is less than the confidence threshold for the first instruction stream.

9. The method of claim 8, wherein the first remedial action comprises generating a warning.

10. The method of claim 8, wherein the first remedial action comprises determining a solution to raise the aggregated confidence level above the confidence threshold.

11. The method of claim 7, further comprising storing the aggregated confidence level in a dedicated register.

12. A system for managing confidence levels in a computing system, the system comprising:
a logic unit for determining a first confidence level associated with a first operation performed in the computing system,
wherein the first confidence level indicates probability that the first operation was performed successfully, and
wherein the first confidence level is calculated based on attributes of one or more components in the computing system.

13. The system of claim 12, further comprising:
a logic unit for comparing the first confidence level to a first confidence threshold for the first operation; and
a logic unit for taking a first remedial action, in response to determining that the first confidence level is less than the first confidence threshold.

14. The system of claim 13, wherein the first remedial action comprises generating a warning.

15. The system of claim 13, wherein the first remedial action comprises determining a solution to raise the first confidence level above the first confidence threshold.

16. The system of claim 12, further comprising:
a logic unit for determining a second confidence level associated with a second operation performed in the computing system, wherein the first and second operations are part of a first instruction stream; and
a logic unit for determining an aggregated confidence level associated with the first instruction stream by combining the first and second confidence levels into a single value.

17. The system of claim 16, further comprising:
a logic unit for comparing the aggregated confidence level with a second confidence threshold for the first instruction stream; and
a logic unit for taking a second remedial action, in response to determining that the aggregated confidence level is less than the second confidence threshold.

18. The system of claim 17, wherein the second remedial action comprises generating a warning.

19. The system of claim 17, wherein the second remedial action comprises determining a solution to raise the aggregated confidence level above the second confidence threshold.

20. The system of claim 12, further comprising a logic unit for storing the aggregated confidence level in a dedicated register.
